(19) United States
(12) Patent Application Publication
(10) Pub. No.: US 2019/0377112 A1
(43) Pub. Date: Dec. 12, 2019

(54) TRANSPARENT FILM HAVING IMPROVED LIGHTING PERFORMANCE, AND MANUFACTURING METHOD THEREFOR

(71) Applicant: DIYPRO CO., LTD., Suwon-si Gyeonggi-do (KR)

(72) Inventor: Myung Joong KIM, Gwanak-gu, Seoul (KR)

(21) Appl. No.: 16/463,518

(22) PCT Filed: Nov. 25, 2016
(86) PCT No.: PCT/KR2016/013692

§ 371 Date: May 23, 2019

(30) Foreign Application Priority Data
Nov. 25, 2016 (KR) 10-2016-0157955

(51) Int. Cl. G02B 5/20; C08J 5/08; C08L 33/12; C08L 67/00; C09J 7/20; G02B 1/04

(52) U.S. Cl. CPC G02B 5/208; C08J 5/08; G02B 1/04; C08L 67/00; C09J 7/20; C08L 33/12

(57) ABSTRACT

A transparent film having improved lighting performance, and a manufacturing method therefor are disclosed. According to a preferable embodiment of the present invention, the transparent film having improved lighting performance has a plurality of transmission and refraction parts formed at predetermined intervals on the surface of a support film, a cross-section of each of the transmission and refraction parts comprises a flat part, which has a predetermined height from the planar surface of the support film, and an inclined part extended from one end of the flat part to the plane of the support film, and the flat part is bonded to a glass window by an adhesive. Sunlight directly entering through the glass window is refracted and then is directed toward the bottom surface or is reflected at the inclined part and then is directed toward the ceiling, thereby entering deeply into an indoor place, and thus lighting effects are improved. In addition, since light entering perpendicularly to the flat part is transmitted in the same direction without being refracted, an indoor person can observe an outside landscape or an outside object as is, and thus the frustration of being incapable of observing the outside when using a window blind has been solved.

### TECHNICAL FIELD

The present invention relates to a transparent film and a manufacturing method thereof, and more particularly, to a transparent film having improved lighting performance and a manufacturing method thereof.

### BACKGROUND ART

As the desire for quality of life increases recently, the desire to increase in natural light also increases at the same time. However, the difficulty of adjusting a room temperature due to an influx of sunlight and the difference in amount of light is remarkable in the vicinity of the window and far from the window. In addition, in the case of an office having a large window, there is a problem that a worker has a difficulty to see an LCD monitor due to the direct influx of outside sunlight when the worker is placed in the vicinity of the window, and a problem that that the outsider's eyes are not blocked additionally occurs. To solve this problem, many households and offices have been controlling the lighting by using blinds and barrier films.

However, in the case of the blinds and the barrier films, all the blinds and barrier films may not effectively use the incident natural light and generate their effects by completely blocking, partially blocking, or attenuating the sunlight. However, in this case, since an amount of light introduced into the room is reduced, electric energy is used for the lighting using room lights from the daytime. In the case of the blinds, there is a problem that people who live indoors feel uncomfortable due to the fact that gaze is blocked by 100% to make it impossible to view the scenery outside the window through the window.

### DISCLOSURE OF THE INVENTION

### Technical Problem

An object to be solved by the present invention is to provide a transparent film having lighting performance, in which people's gaze to a room from the outside is blocked while allowing outdoor natural light to be introduced into a depth region of an indoor place, and light transmittance to the outside in indoors is improved to solve stuffy due to invisibility of indoor residents while saving electric energy for indoor lighting, and a manufacturing method thereof.

### Technical Solution

A transparent film according to a preferred embodiment of the present invention for solving the above problem includes: a support film; and a plurality of transmission and refraction parts formed on one plane of the support film and disposed at a predetermined interval to adhere to a glass window, wherein a cross-section of each of the transmission and refraction parts includes: a flat part having a predetermined height from the plane of the support film; and an inclined part extending from the flat part to the plane of the support film, wherein the flat part adheres to the glass window by an adhesive.

Also, the inclined part may extend from one end of the flat part to the plane of the support film.

Also, the inclined parts of the transmission and refraction parts may be formed in the same direction.

Also, the interval between the plurality of transmission and refraction parts may be 50% of a length of the flat part.

A transparent film according to another preferred embodiment of the present invention for solving the above problem is a transparent film, in which a plurality of flat parts and inclined parts are alternately formed on one surface thereof, wherein the plurality of inclined parts extend from one end of the flat part to the inside of the transparent film and formed in the same direction, and the flat part adheres to a glass window by an adhesive.

Also, projected lengths of the inclined parts and the flat parts may be the same.

Also, an angle between each of the inclined parts and the plane of the support film may range of 30 degrees to 60 degrees.

Also, the adhesive may be applied to the flat part.

Also, the transparent film may further include an adhesive transfer film which has one surface coated with the adhesive, of which the surface coated with the adhesive adheres to the flat part, and by which the adhesive is transferred to the flat part when being detached from the flat part.

Also, the support film may be a polyester film, and the plurality of transmission and refraction parts may be made of a UV-curable resin.

Also, the transparent film may further include an adhesion film including: a transparent support member preventing yellowing of the transmission and refraction parts; a first adhesion layer formed on one surface of the transparent support member; a second adhesion layer formed on the other surface of the transparent support member; and a protection film protecting the first adhesion layer, wherein the second adhesion layer adheres to the flat part, and the first adhesion layer adheres to the glass window by removing the protection film.

A method for manufacturing a transparent film according to a preferred embodiment of the present invention for solving the above problem includes: (a) applying a ultraviolet (UV)-curable resin to a support film; (b) forming a plurality of transmission and refraction parts, which are disposed on the UV-curable resin at a predetermined interval by using a roller, on which patterns of flat parts and inclined parts are formed, to adhere a glass window; and (c) irradiating UV rays onto the UV-curable resin to cure the UV-curable resin, wherein a cross-section of each of the plurality of transmission and refraction parts includes a flat part having a predetermined height from a plane of the support film and an inclined part extending from the flat part to the plane of the support film, and the inclined parts provided in the plurality of transmission and refraction parts extend from one cross-section of two cross-sections of the flat part to the plane of the support film and are formed in the same direction.

Also, the interval between the plurality of transmission and refraction parts may be 50% a length of the flat part.

A method for manufacturing a transparent film according to another preferred embodiment of the present invention for solving the above problem includes: (a) heating a polymethylmethacrylate (PMMA) film; (b) performing processing to alternately form a plurality of flat parts and inclined parts on a plane of the heated PMMA film by using a roller on which patterns of the flat part and the inclined part are formed; and (c) cooling the PMMA film on which the plurality of flat parts and inclined parts are alternately formed on the plane to cure the PMMA film, wherein the plurality of inclined parts extend from one cross-section of two cross-sections of the flat part to the inside of the PMMA film and are formed in the same direction.

Also, projected lengths of the inclined parts and the flat parts may be the same.

Also, an angle between each of the inclined parts and the plane of the support film may range of 30 degrees to 60 degrees.

Also, the method may further include allowing an adhesive transfer film, which has one surface coated with the adhesive, of which the surface coated with the adhesive adheres to the flat part, and by which the adhesive is transferred to the flat part when being detached from the flat part, to adhere to the flat part.

Also, the method may further include allowing a second adhesion layer of an adhesion film, which comprises: a transparent support member preventing yellowing of the transmission and refraction parts; a first adhesion layer formed on one surface of the transparent support member; the second adhesion layer formed on the other surface of the transparent support member; and a protection film protecting the first adhesion layer, to adhere to the flat part, wherein the first adhesion layer may adhere to a glass window by removing the protection film.

### Advantageous Effects

In the transparent film having the improved lighting performance according to the preferred embodiment of the present invention, the plurality of transmission and refraction parts may be formed at a predetermined interval on the support film surface. The cross-section of each of the transmission and refraction parts may include the flat part having the predetermined height from the plane of the support film and the inclined part extending from the one end of the flat part to the plane of the support film. Here, the flat part may adhere to the glass window by the adhesive. In the case of sunlight that is directly incident through the glass window, since the sunlight is refracted to be directed to the floor surface or reflected by the reflection part to face the ceiling, the sunlight may be introduced up to the deep place of the room to improve the lighting effect. Also, when the light is incident to be perpendicular to the flat part, the light may be transmitted in the same direction without being refracted. Thus, the person in the room may observe the external scenery and the external objects at it is to solve the stuffiness that occurs when the person does not observe the outside due to the blind.

### BRIEF DESCRIPTION OF THE DRAWINGS

FIG. 1a is a view illustrating a structure of a transparent film having improved lighting performance according to a first preferred embodiment of the present invention.

FIG. 1b is a view for explaining the structure of the transparent film according to a modified example of the first preferred embodiment of the present invention.

FIG. 2 is a process view for explaining a method for manufacturing the transparent film having the improved lighting performance according to the first preferred embodiment of the present invention.

FIG. 3 is a view illustrating a structure of a transparent film having improved lighting performance according to a second preferred embodiment of the present invention.

FIG. 4 is a process view for explaining a method for manufacturing the transparent film having the improved lighting performance according to the second preferred embodiment of the present invention.

FIG. 5 is a view illustrating a path of light when the transparent film according to the preferred embodiment of the present invention is installed.

### MODE FOR CARRYING OUT THE INVENTION

Preferred embodiments of the present invention will be described below in more detail with reference to the accompanying drawings.

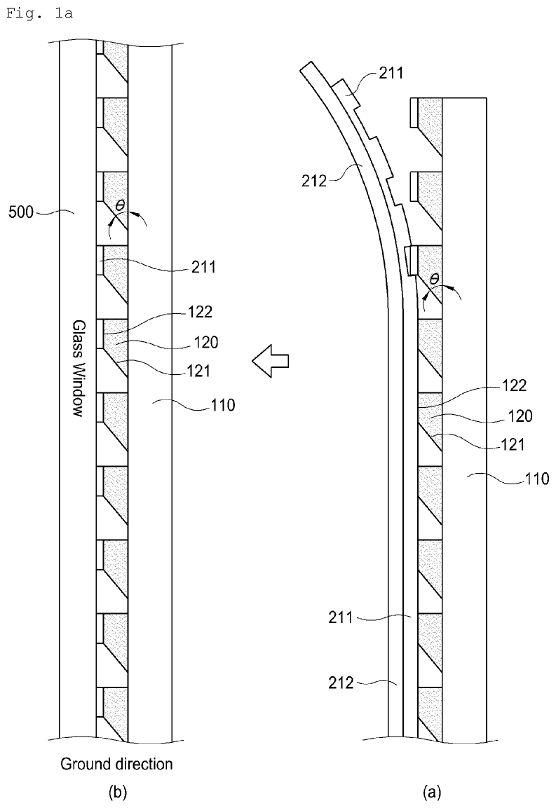

FIG. 1a is a view illustrating a structure of a transparent film having improved lighting performance according to a first preferred embodiment of the present invention.

Referring to FIG. 1a, a transparent film having improved lighting performance according to a first preferred embodiment of the present invention includes a support film 110 and a plurality of transmission and refraction parts 120 disposed on one plane of the support film 110 and disposed at a predetermined interval to adhere to a glass window 500.

The support film 110 may perform a function of supporting the plurality of transmission and refraction parts 120 so that the transmission and refraction parts 120 are maintained at the predetermined interval with respect to each other and may be provided as a polyester film.

Each of the transmission and refraction parts 120 has a cross-section including a flat part 121 disposed at a predetermined height from the plane of the support film 110 and an inclined part 122 extending from one end of the flat part 121 to the plane of the support film 110. The flat part 121 may adhere to the glass window 500 by an adhesive 211 so that the transmission and refraction parts 120 are installed on the glass window 500. In the preferred embodiment of the present invention, the transmission and refraction part 120 is made of a transparent ultraviolet-curable resin.

The inclined part 122 of the transmission and refraction part 120 extends from the one end of the flat part 121 to the plane of the support film 110. In the preferred embodiment of the present invention, all the inclined parts 122 are formed in the same direction. The top and bottom of the transparent film according to the preferred embodiment of the present invention is specified. When a user purchases the transparent film of the present invention, an end of the film that is indicated as the bottom is installed to face the ground. In this case, the inclined part 122 may extend in a direction of the ground.

Furthermore, an angle θ defined between the inclined part 122 and the support film 110 may preferably range of 30 degrees to 60 degrees. The transparent film of the present invention may be produced as a separate film for each season. That is, the angle between the inclined part 122 and the support film 110 is differently set for each seasonal product. This is done because the altitude of the sun is changed according to the season. In the preferred embodiment of the present invention, although the angle between the inclined part 122 and the support film 110 is set to 37 degrees to 55.5 degrees, it will be appreciated by those skilled in the art that the angle applied to the actual product is set differently according to the latitude of the place at which the product is installed.

Also, it is preferable that lengths of the inclined part 122 and the flat part 121 projected to the plane of the support film 110 are the same. However, it is clear that the projected length of the inclined part 122 and the projected length of the flat part 121 are designed to be different from each other according to design specifications.

The transparent film according to the first preferred embodiment of the present invention is sold in a state in which an adhesive transfer film 212 adheres as illustrated at a right side of FIG. 1a (see FIG. 1a(a)). Here, the user may remove the adhesive transfer film 212 to attach the transparent film to the glass window 500.

An adhesive 211 is applied to one surface of the adhesive transfer film 212. The surface coated with the adhesive 211 adheres to the flat part 121. When the user removes the adhesive transfer film 212, the adhesive 211 applied to the one surface of the adhesive transfer film 212 may be transferred to the flat part 121 to remain on the flat part 121. The user may attach the transparent film to the glass window 500 by using the adhesive 211 remaining on the flat part 121.

In a modified embodiment of the first embodiment of the present invention, the adhesive film fixedly adheres to the flat part 121 and then is attached to the glass window 500, instead of a method in which the adhesive 211 is transferred to the flat part 121 by using the adhesive transfer film 212 illustrated in FIG. 1a to attach the transparent film to the glass window 500.

FIG. 1b is a view for explaining the structure of the transparent film according to a modified example of the first preferred embodiment of the present invention.

Referring to FIG. 1b, the transparent film according to the modified embodiment is sold in a state in which the adhesive film fixedly adheres to the flat part 121.

Here, the adhesive film includes a transparent support member 222, which prevents yellowing of the transmission and refraction part 120, a first adhesion layer 221 formed on one surface of the transparent support member 222, a second adhesion layer 223 formed on the other surface of the transparent support member 222, and a protection film 224 protecting the first adhesion layer 221. The second adhesion layer 223 fixedly adheres to the flat part 121 of the transmission and refraction part 120 formed on the support film 110.

When the transparent and refraction part 120 made of an ultraviolet-curable resin is exposed to the sunlight for a long time, a yellowing phenomenon that gradually changes to a yellow color may occur. Here, the transparent support member 222 of the adhesive film may prevent the yellowing phenomenon from occurring. The transparent support member 222 may be formed through a combination of polyester (PET) and polymethylmethacrylate (PMMA) resins.

The user purchases the corresponding transparent film and then remove the protection film 224 to attach the first adhesion layer 221 to the glass window 500, thereby installing the transparent film of the present invention on the glass window 500.

Although the plurality of transparent and refraction parts 120 described with reference to FIG. 1a may contact each other, the plurality of transparent and refraction parts 120 may be spaced a predetermined distance from each other as illustrated in FIG. 1b. Here, the spaced distance may preferably range of 0 to the length of the plane of the flat part 121 (or the inclined part 122). As the spaced distance decreases more and more, the transparent and refraction parts 120 may have a cross-sectional shape in which the transparent and refraction parts 120 contact each other. However, the example illustrated in FIG. 1b illustrates an example in which the distances of the planes of the flat part 121 and the inclined part 122 are the same, and 50% of the distance of the plane is set to the spaced distance. The spaced distance may be set to be larger according to the design specifications.

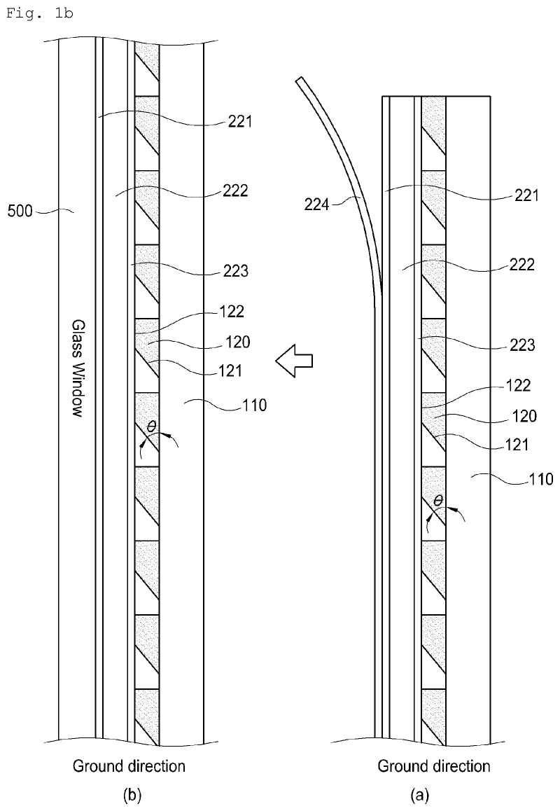

FIG. 2 is a process view for explaining a method for manufacturing the transparent film having the improved lighting performance according to the first preferred embodiment of the present invention.

The method for manufacturing the transparent film according to the first preferred embodiment of the present invention will be described with reference to FIG. 2. First, the UV-curable resin is applied to the support film 110 (see FIG. 2(a)). The polyester film may be applied as the support film 110 as described above.

Thereafter, a roller 600 on which patterns of the flat part 121 and the inclined part 122 are formed rotates to allow the support film 110 to pass therethrough, thereby forming the patterns of the surface of the roller 600 on the UV-curable resin (see FIG. 2(b)). The plurality of transparent and refraction parts 120, which are disposed at a predetermined interval to adhere to the glass window 500, are formed on the UV-curable resin by the roller 600.

When the transparent and refraction parts 120 are formed at the predetermined interval, ultraviolet rays are irradiated onto the transparent and refraction parts 120 to cure the transparent and refraction parts 120 (see FIG. 12(c)).

When the transmission and refraction parts 120 formed on the support film 110 are cured, the adhesive transfer film 212, which are previously prepared, adheres to the support film 110 on which the transmission and refraction parts 120 are formed so that the adhesive 211 is transferred to the flat part 121 of each of the transmission and refraction parts 120 (see FIG. 2(d)). As illustrated in FIG. 2 (d), the transparent film of the present invention is sold in the state in which the adhesive transfer film 212 and the support film 110, on which the transmission and refraction parts 120 are formed, adhere to each other. In order to prevent the adhesive 211 from being cured, the transparent film may be sold in a sealed state.

Thereafter, when the user needs to use the transparent film of the present invention after purchasing the transparent film, if the adhesive transfer film 212 is detached as illustrated in FIG. 2(e), the adhesive 211 applied to the adhesive transfer film 212 may remain on the transmission and refraction parts 120. Thus, the user may attach the corresponding surface to the glass window 500 to install the transparent film of the present invention to the glass window 500.

The transparent film according to the first preferred embodiment of the present invention has been described.

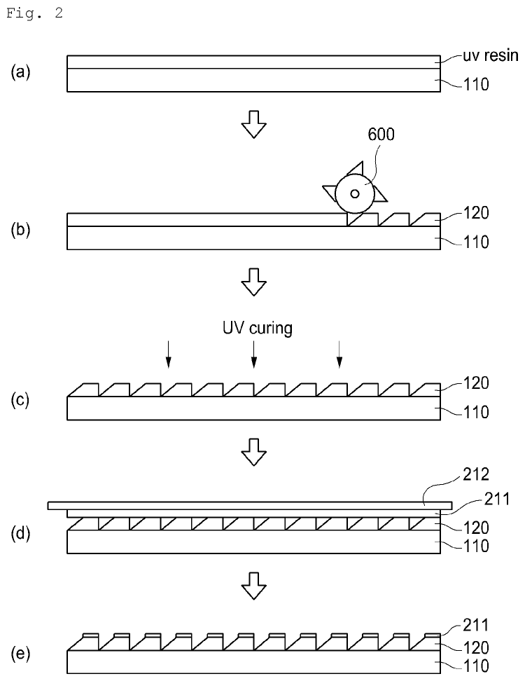

FIG. 3 is a view illustrating a structure of a transparent film having improved lighting performance according to a second preferred embodiment of the present invention.

In the case of the first embodiment, the transmission and refraction parts 120 are formed on the support film 110 by using the UV-curable resin. However, a transparent film according to a second preferred embodiment of the present invention is different from the transparent film according to the first embodiment in that the transparent film is integrally formed by using a PMMA film 310.

Referring to FIG. 3, the transparent film according to the second embodiment has one surface on which a plurality of flat parts 311 and inclined parts 312 are alternately formed. Each of the plurality of inclined parts 312 extends from one end of each of the flat parts 311 to the inside of the transparent film. Thus, the plurality of inclined parts 312 are formed in the same direction. Also, the flat part 311 may be a surface that adheres to a glass window 500 by an adhesive 211. Like the first embodiment, it is preferable that the flat part 311 has substantially the same length as a projected length on a plane of the inclined part 312. However, this may be changed according to design specifications.

The transparent film according to the second embodiment is generally the same as that according to the first embodiment except that the transparent film is integrally formed. For example, an angle θ defined by the inclined surface and the horizontal plane of the transparent film may preferably range of 30 degrees to 60 degrees. However, the angle may be changed according to the latitude of the installed position of the transparent film.

Also, the transparent film according to the second embodiment may be sold in a state of adhering to an adhesive transfer film 212 (see FIG. 3(a)). When the user removes the adhesive transfer film 212 so as to install the transparent film on a glass window 500, the adhesive 211 may remain on the flat part 311. Then, when the transparent film is attached so that the flat part 311 faces the glass window 500, the transparent film may be installed on the glass window 500 by the adhesive 211 (see FIG. 3(b)).

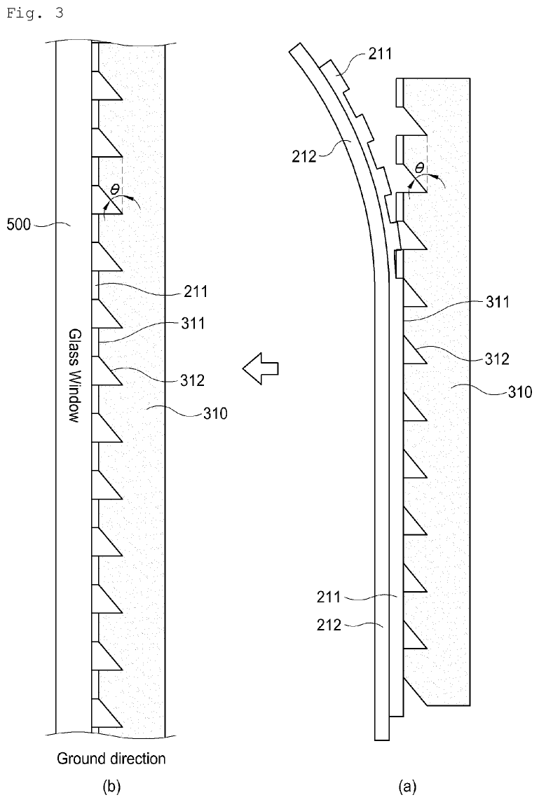

FIG. 4 is a process view for explaining a method for manufacturing the transparent film having the improved lighting performance according to the second preferred embodiment of the present invention.

A method for manufacturing the transparent film having improved lighting performance according to the second preferred embodiment of the present invention will be described with reference to FIG. 4. First, as illustrated in FIG. 4(a), the PMMA film 310 is prepared and then heated by a heating unit to make it possible to form a pattern.

Thereafter, a roller 600 on which patterns of the flat part 311 and the inclined part 312 are formed rotates to allow the heated PMMA film 310 to pass therethrough, thereby forming the patterns of a surface of the roller 600 on a surface of the PMMA film 310 (see FIG. 4(b)). The patterns of the flat part 311 and the inclined part 312 are alternately formed on the PMMA film 310 by the roller 600.

When the flat part 311 and the inclined part 312 are formed on the PMMA film 310, the flat part 311 and the inclined part are cooled by using a cooling unit to cure the patterns of the flat part 311 and the inclined part 312, which are formed on the surface of the PMMA film 310, as it is (see FIG. 4(c)). When the patterns are cured, an adhesive transfer film 212, on which an adhesive 211 is applied, adheres to the transparent film 310 made of a PMMA material to complete a product (see FIG. 4(d)).

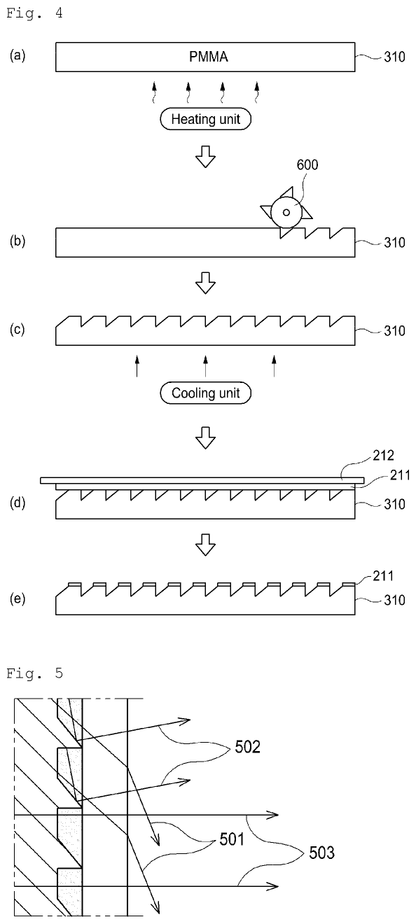

FIG. 5 is a view illustrating a path of light when the transparent film according to the preferred embodiment of the present invention is installed.

Referring to FIG. 5, light, which is obliquely incident into the flat part 121, of light incident into the transparent film is expressed as reference numeral 501. The light is primarily refracted by the flat part 121 and then refracted again by the surface of the support film 110 so as to be directed to a floor surface.

Furthermore, light incident into a surface perpendicular to the flat part 121 is expressed as reference numeral 502. The light is totally reflected by the inclined part 122 so as to be directed to a ceiling in an indoor place.

Also, in the case of the light that is incident to be perpendicular to the flat part 121, the light is expressed as reference numeral 503. The light is directed in the incident direction without being refracted. Thus, the person located in the indoor place may directly recognize an external object as it is in a front direction through the transparent film.

As illustrated in FIG. 5, in the case of the sunlight that is directly incident through the glass window 500, the light is refracted to be directed to the floor surface or the ceiling. Thus, since the sunlight is introduced up to the deep place of the indoor place, a lighting effect may be improved.

In addition, in the case of the light incident to be perpendicular to the flat part 121, the light may be transmitted in the same direction without being refracted. Thus, the person in the room may observe the external scenery and the external objects at it is to solve the stuffiness that occurs when the person can not observe the outside due to the blind.

Until now, preferred embodiments of the present invention have been described mainly. It will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A transparent film comprising:
a support film; and
a plurality of transmission and refraction parts formed on one plane of the support film and disposed at a predetermined interval to adhere to a glass window, wherein a cross-section of each of the transmission and refraction parts comprises:
a flat part having a predetermined height from the plane of the support film; and
an inclined part extending from the flat part to the plane of the support film,
wherein the flat part adheres to the glass window by an adhesive.

2. The transparent film of claim 1, wherein the inclined part extends from one end of the flat part to the plane of the support film.

3. The transparent film of claim 2, wherein the inclined parts of the transmission and refraction parts are formed in the same direction.

4. The transparent film of claim 2, wherein the interval between the plurality of transmission and refraction parts is 50% of a length of the flat part.

5. A transparent film, in which a plurality of flat parts and inclined parts are alternately formed on one surface thereof,
wherein the plurality of inclined parts extend from one end of the flat part to the inside of the transparent film and formed in the same direction, and
the flat part adheres to a glass window by an adhesive.

6. The transparent film of claim 5, wherein projected lengths of the inclined parts and the flat parts are the same.

7. The transparent film of claim 1, wherein an angle between each of the inclined parts and the plane of the support film ranges of 30 degrees to 60 degrees.

8. The transparent film of claim 1, wherein the adhesive is applied to the flat part.

9. The transparent film of claim 8, further comprising an adhesive transfer film which has one surface coated with the adhesive, of which the surface coated with the adhesive adheres to the flat part, and by which the adhesive is transferred to the flat part when being detached from the flat part.

10. The transparent film of claim 1, wherein the support film is a polyester film, and the plurality of transmission and refraction parts are made of a UV-curable resin.

11. The transparent film of claim 1, further comprising an adhesion film comprising:
a transparent support member preventing yellowing of the transmission and refraction parts;
a first adhesion layer formed on one surface of the transparent support member;
a second adhesion layer formed on the other surface of the transparent support member; and
a protection film protecting the first adhesion layer,
wherein the second adhesion layer adheres to the flat part, and the first adhesion layer adheres to the glass window by removing the protection film.

12. A method for manufacturing a transparent film, the method comprising:
(a) applying a ultraviolet (UV)-curable resin to a support film;
(b) forming a plurality of transmission and refraction parts, which are disposed on the UV-curable resin at a predetermined interval by using a roller, on which patterns of flat parts and inclined parts are formed, to adhere a glass window; and
(c) irradiating UV rays onto the UV-curable resin to cure the UV-curable resin,
wherein a cross-section of each of the plurality of transmission and refraction parts comprises a flat part having a predetermined height from a plane of the support film and an inclined part extending from the flat part to the plane of the support film, and
the inclined parts provided in the plurality of transmission and refraction parts extend from one cross-section of two cross-sections of the flat part to the plane of the support film and are formed in the same direction.

13. The method of claim 12, wherein the interval between the plurality of transmission and refraction parts is 50% of a length of the flat part.

14. A method for manufacturing a transparent film, the method comprising:
(a) heating a polymethylmethacrylate (PMMA) film;
(b) performing processing to alternately form a plurality of flat parts and inclined parts on a plane of the heated PMMA film by using a roller on which patterns of the flat part and the inclined part are formed; and
(c) cooling the PMMA film on which the plurality of flat parts and inclined parts are alternately formed on the plane to cure the PMMA film,
wherein the plurality of inclined parts extend from one cross-section of two cross-sections of the flat part to the inside of the PMMA film and are formed in the same direction.

15. The method of claim 12, wherein projected lengths of the inclined parts and the flat parts are the same.

16. The method of claim 12, wherein an angle between each of the inclined parts and the plane of the support film ranges of 30 degrees to 60 degrees.

17. The method of claim 12, further comprising allowing an adhesive transfer film, which has one surface coated with the adhesive, of which the surface coated with the adhesive adheres to the flat part, and by which the adhesive is transferred to the flat part when being detached from the flat part, to adhere to the flat part.

18. The method of claims 12, further comprising allowing a second adhesion layer of an adhesion film, which comprises: a transparent support member preventing yellowing of the transmission and refraction parts; a first adhesion layer formed on one surface of the transparent support member; the second adhesion layer formed on the other surface of the transparent support member; and a protection film protecting the first adhesion layer, to adhere to the flat part,
wherein the first adhesion layer adheres to a glass window by removing the protection film.
